(19) United States
(12) Patent Application Publication
(10) Pub. No.: US 2008/0079255 A1
(43) Pub. Date: Apr. 3, 2008

(54) Washable coloring book

(76) Inventor: Michael L. Nakamura, Crystal Lake, IL (US)

Correspondence Address: Kevin D. Erickson;Pauley Petersen & Erickson, Suite 365, 2800 West Higgins Road, Hoffman Estates, IL, 60169, US

(21) Appl. No.: 11/542,614

(22) Filed: Oct. 2, 2006

(51) Int. Cl. B42D 3/00

(52) U.S. Cl. 281/36

(57) ABSTRACT

A coloring book has a plurality of pages made of washable material, such as fabric and/or a coated substrate. The pages of the coloring book are disposed between a front cover portion and the back cover portion of the cover. The pages of the coloring book may be individually removable from the coloring book.

### BACKGROUND OF THE INVENTION

1. Field of the Invention

This invention relates generally to a coloring book, and, more particularly, to a coloring book having colorable designs printed on pages made of washable material such that colors can be removed from the colorable designs following each coloration and the colorable designs can be reused for multiple uses.

2. Discussion of Related Art

Coloring books are very popular with children, especially younger children. Coloring books usually include various colorable designs, such as, for example, flowers, cars, animals, etc., for coloring with a child's choice of colors using crayons and/or markers. The pages of many conventional coloring books are made of regular paper and/or cardboard, which renders substantial removal of colors therefrom very difficult if not impossible. Once a child colors the colorable design with his or her choice of colors, aside from re-coloring the design with another set of colors placed over the existing colors, after coloration, the colors usually cannot be removed from the pages of a conventional coloring book without destroying the coloring book and/or its pages. Therefore, conventional coloring books are generally not reusable for multiple colorations and are usually discarded after a single use.

There is a need or a desire for a coloring book having pages made of washable material so that, after coloration, the coloring book, or its individual pages, could be washed to remove colors from the colorable designs, and so that such cleared colorable designs could be used for another coloration.

### SUMMARY OF THE INVENTION

A general object of the invention is to provide a coloring book having pages made of washable material. The coloring book of this invention preferably also provides removable pages, thereby facilitating removal of colors from the individual pages.

The general and other objects of the invention can be attained, at least in part, through a coloring book including a plurality of pages of washable material bound together. At least one page of the plurality of pages includes a colorable design. Following coloration, each page of the plurality of pages is washable to remove color from the colorable design.

The invention further comprehends a coloring book including a cover comprising a front cover portion and a back cover portion and a plurality of pages of washable material bound along an edge and disposed between the front cover portion and the back cover portion. At least one page of the plurality of pages comprises a colorable design and colors are removable from the colorable design such that the colorable design is reusable for multiple uses.

Other objects and advantages will be apparent to those skilled in the art from the following detailed description taken in conjunction with the appended claims and drawings.

### BRIEF DESCRIPTION OF THE DRAWINGS

FIG. 1 is a perspective view of a coloring book, in an open position and showing exposed pages, according to one embodiment of this invention.

FIG. 2 is a side view of the coloring book shown in FIG. 1, showing a removable page.

FIG. 3 is a perspective view of a back cover portion of the coloring book shown in FIG. 1, showing a pouch attached to the back cover portion.

FIG. 4 is a partial sectional view of a coloring book, showing pages made of a single folded sheet of fabric, according to another embodiment of this invention.

FIG. 5 is a perspective view of a coloring book, in an open position, according to yet another embodiment of this invention

FIG. 6 is a perspective view of a coloring book, in an open position, according to still another embodiment of this invention.

### DETAILED DESCRIPTION OF THE INVENTION

The present invention provides a coloring book. The coloring book has a plurality of pages made of washable material, such as, for example, fabric or a coated substrate. The plurality of pages are preferably disposed between a cover formed outside and generally around the plurality of pages. At least one colorable design is desirably printed on either side, or both sides, of each page of the plurality of pages for coloration with crayons, markers and/or other coloring instruments. The plurality of pages are preferably detachable from the coloring book as a unit and/or individually for more convenient removal of colors therefrom.

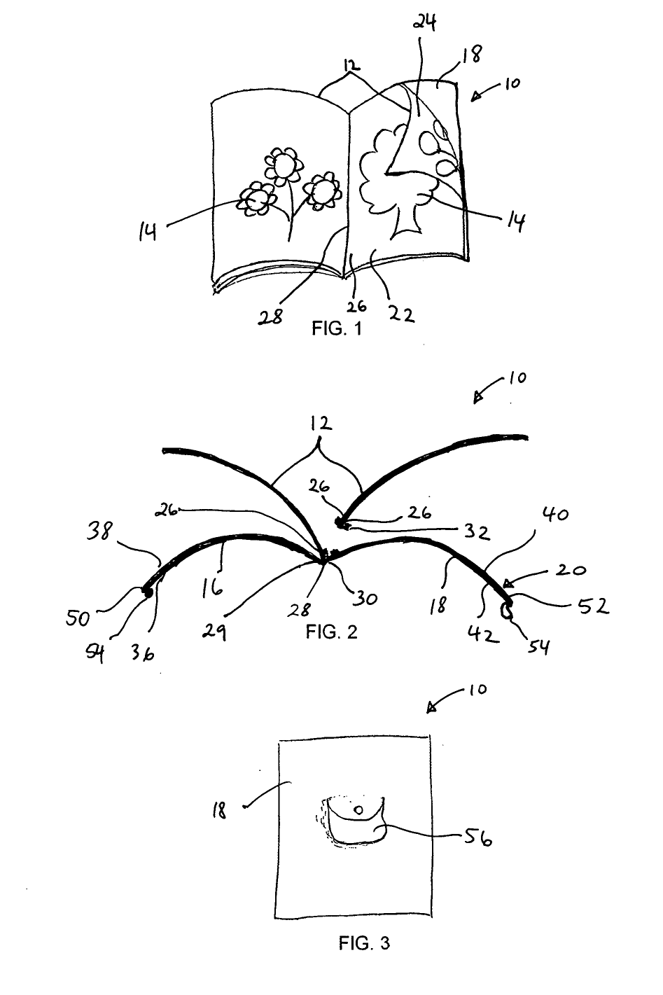

Exemplary embodiments of coloring book are shown in FIGS. 1-6. As shown in FIGS. 1-3, coloring book 10 comprises a plurality of pages 12 having colorable designs 14 printed thereon. Pages 12 are preferably disposed and bound between front cover portion 16 and back cover portion 18 of cover 20.

At least one page of the plurality of pages 12 is made of washable material. By “washable” material, it is understood any natural or man-made material capable of retaining colors placed thereon using crayons, markers, or other coloring instruments, but which releases such colors when treated with water or other cleaning substance.

For example, in one embodiment of the invention, shown in FIG. 1, plurality of pages 12 are made of fabric. Examples of fabrics useful in constructing the coloring book of this invention include natural and synthetic fabrics, such as, without limitation, cotton, rayon, and polyester materials. Desirably, the portions of coloring book 10 which include printed colorable designs 14 and/or graphics and/or text are made from materials that are appropriate for printing.

After coloration, fabric pages 12 are desirably washed in water, optionally containing detergent and/or other cleaning substance, to remove colors from colorable designs 14 without substantially affecting the quality of the fabric and/or individual pages 12. Desirably, fabric pages 12 of coloring book 10 of the present invention can be placed in a regular home or commercial washing machine and washed to remove colors therefrom. After washing, fabric pages 12 of coloring book 10 of this invention may be ironed to remove wrinkles, if any. Alternatively, pages 12 of coloring book 10 of this invention can be made of wrinkle-free fabric or other washable material. Following cleaning, colorable designs 14, which are cleared of colors during the cleaning process, may be colored again with a new choice of colors. Thus, because pages 12 of coloring book 10 of this invention are made of washable material, after coloration, colors can be removed from colorable designs 14, and coloring book 10 can be reused for another coloration. This process can be repeated as many times as desired, and coloring book 10 of this invention can be colored multiple times.

In another embodiment of the present invention, at least one of the plurality of pages comprises a composite material, such as, for example, a coated substrate. Coating on the substrate is preferably smooth for easier coloring and/or cleaning. Colors can be removed from the pages comprised of a coated substrate by wiping the pages clean with a cloth, optionally containing a cleaning substance, or the entire coloring book may be placed into a washing machine, as described above. As will be appreciated, various and alternative washable materials available in the art can be used for the pages of the coloring book of this invention.

With reference to FIGS. 1-3, each page of plurality of pages 12 has two opposing sides, namely, front page side 22 and back page side 24 opposite front page side 22. At least one of front page side 22 or back page side 24 includes at least one colorable design 14, text and/or graphics. Each of the plurality of pages 12 includes page interior edge portion 26 disposed at or adjacent to seam 28 of coloring book 10. Desirably, each of the plurality of pages 12 is removably attachable at or near page interior edge portion 26 to corresponding page interior edge portion 26 of at least one other page of the plurality of pages 12. The page facing front cover portion 16 and the page facing back cover portion 18 may similarly be removably attachable at or near page interior edge portion 26 to corresponding front cover interior edge portion 29 of front cover portion 16 or back cover interior edge portion 30 of back cover portion 18, respectively. Page fastening elements 32, such as hook and loop fasteners, snaps, zippers, and/or other fastening elements known to those skilled in the art, are desirably disposed at or around page interior edge portion 26 and/or front cover interior edge portion 29 and/or back cover interior edge portion 30, for removably attaching each page to at least one other page and/or front cover portion 16 and/or back cover portion 18.

Removable pages 12 facilitate cleaning and/or washing of the coloring book 10 of the present invention, as individual pages 12 can be individually removed from coloring book 10 for cleaning/washing and subsequently reattached for coloring. Alternatively, the entire coloring book 10 can be washed at once by, for example, placing coloring book 10 into a washing machine. Removable pages 12 also may facilitate coloring, as individual pages 12 can be removed from coloring book 10 for easier handling. Also, coloring book 10 of this invention can be conveniently shared by many users, as removable pages 12 are easily removable from coloring book 10.

Coloring book 10 of this invention preferably further comprises cover 20 formed outside plurality of pages 12 and including front cover portion 16 and back cover portion 18. Front cover portion 16 and back cover portion 18 define the front and the back of coloring book 10, respectively. Front cover portion 16 is the front cover of coloring book 10 and back cover portion 18 is the back cover of coloring book 10. Front cover portion 16 and back cover portion 18 may be formed as one element. Alternatively, front cover portion 16 and back cover portion 18 may be formed as two separate elements bound together to form cover 20 of coloring book 10.

Each of front cover portion 16 and back cover portion 18 includes two sides. Front cover portion 16 includes front cover first side 36 and front cover second 38 side opposite front cover first side 36. Back cover portion 18 includes back cover first side 40 and back cover second side 42 opposite back cover first side 40. Front cover second 38 side and back cover first side 40 form the inside surfaces of cover 20 of coloring book 10, and front cover first side 36 and back cover second side 42 form the outside surfaces of cover 20 of coloring book 10. The plurality of pages 12 are disposed between front cover second 38 side and back cover first side 40. Each of the opposing sides of front cover portion 16 and back cover portion 18 may include printed text and/or graphics. Furthermore, each of the opposing sides of front cover portion 16 and back cover portion 18 may include colorable designs 14 to provide additional colorable surface for coloring.

Front cover portion 16 preferably includes front cover interior edge portion 29 disposed at or adjacent to seam 28 of coloring book 10. Similarly, back cover portion 18 preferably includes back cover interior edge portion 30 disposed at or adjacent to seam 28 of coloring book 10. Page interior edge portion 26 of each page is disposed between front cover interior edge portion 29 and back cover interior edge portion 30. Front cover portion 16 and back cover portion 18 may be joined by directly connecting front cover interior edge portion 29 to back cover interior edge portion 30 at seam 28 of coloring book 10. Alternatively, a cover joining element (not shown), such as a removable binding, may be disposed between and connect front cover interior edge portion 29 and back cover interior edge portion 30.

Front cover portion 16 has front cover exterior edge portion 50 opposite front cover interior edge portion 29. Similarly, back cover portion 18 preferably including back cover exterior edge portion 52 opposite back cover interior edge portion 30. Coloring book 10 according to one embodiment of this invention further comprises at least one cover fastener 54 that joins front cover portion 16 and back cover portion 18 to secure the coloring book 10 in a closed position. The at least one cover fastener 54 desirably comprises two elements, one of which is preferably positioned at or near front cover exterior edge portion 50 and the other is preferably positioned at or near back cover exterior edge portion 52. In one embodiment of this invention, the coloring book 10 includes a plurality of cover fasteners 54 disposed along front cover exterior edge portion 50 and back cover exterior edge portion 52. In one embodiment of the invention, cover fasteners 54 are buttons positioned along front cover exterior edge portion 50 and corresponding loops positioned along back cover exterior edge portion 52. In another embodiment of the invention, cover fasteners 54 are hook fasteners positioned along the front cover exterior edge portion 50 and loop fasteners positioned along the back cover exterior edge portion 52. As will be appreciated by those skilled in the art following the teachings herein provided, the positions of the buttons and the loops as well as the hook and loop fasteners can be reversed or alternatively positioned. As will also be appreciated, various and alternative fasteners available in the art can be used for the fasteners of the coloring book 10 of this invention, such as, for example, snaps and/or zippers.

In one embodiment of this invention, the coloring book 10 further comprises pouch 56 for storing crayons, markers and/or other coloring instruments. Pouch 56 may be a separate element attached to any part of coloring book 10. Alternatively, coloring book 10 may be designed to form pouch 56 as an integral element thereof. FIG. 3 shows a pouch 56 according to one embodiment of the invention.

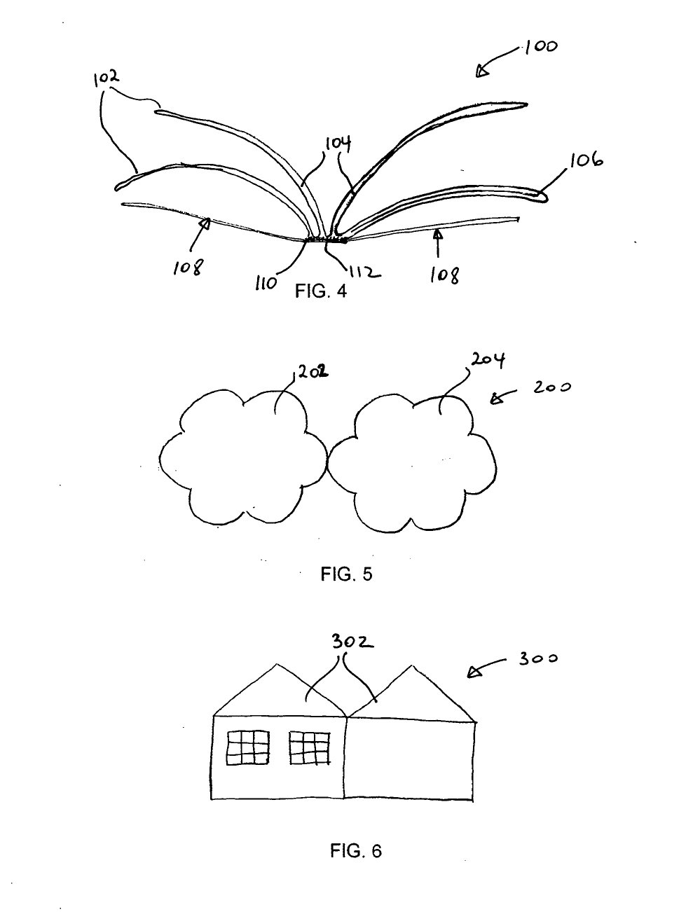

In another embodiment of this invention, such as shown in FIG. 4, coloring book 100 comprises plurality of pages 102 formed from a single folded sheet of washable material, such as fabric or a coated substrate. As shown in FIG. 4, as a result of folding, each of plurality of pages 102 defines pocket 104. Each pocket 104 is formed between the two folded fabric portions of each of pages 102. As pages 102 are formed of a flexible fabric sheet, such configuration is desirable because support sheet 106 can be disposed in each of pockets 104 to support or stiffen individual pages 102 for easier coloring and/or manipulation. Support sheet 106 is desirably formed from a stiffer material than fabric pages 102. The stiffer support sheets 106 provide desirable stiffness for pages 102. To facilitate washing, support sheets 106 are desirably removable from pockets 104 formed within pages 102 of coloring book 100 prior to washing and insertable back into pockets 104 after washing. Support sheets 106 can be formed from various and alternative materials. In one embodiment of this invention, support sheets 106 are made from a nonwoven material, such as a plastic fiber sheet, film, or grid material.

In other embodiments of this invention, where each page of plurality of pages is formed separately, and not from a single folded sheet of fabric, pockets can be formed by joining two or more sheets of fabric or other washable material together to form a page. A support sheet can be placed in such formed pocket.

The plurality of pages 102 shown in FIG. 4 are preferably bound together as a unit and are desirably removable from cover 108 of coloring book 100, also as a unit, for easier washing. The plurality of pages 102 are desirably reattachable to cover 108 of coloring book 100 after washing. To that end, book fastener 110 is preferably disposed along at least a portion of seam 112 of coloring book 100, as shown in FIG. 4. Book fastener 110 is desirably disposed between cover 108 and the plurality of pages 102. In one embodiment of the invention, book fastener 110 is a hook and loop fastener, one part of which is permanently attached to cover 108 and the other part of which is permanently attached to plurality of pages 102 along seam 112 of coloring book 100. Pages 102 can be detached from cover 108 by simply pulling pages 102 away from cover 108. After washing, pages 102 can be reattached to cover 108.

As will be appreciated various and alternative sizes, shapes, and/or configurations are available for the coloring book, the front cover portion, the back cover portion, the pages, support sheets, seams and fasteners of this invention.

As shown in FIG. 1, coloring book 10 has an overall rectangular configuration, although other shapes, such as squares, ovals, circles, and triangles, are available as well. For example, in alternative embodiments of this invention, at least one of the plurality of pages and/or the front cover portion and/or the back cover portion has a fanciful or decorative shape. In one embodiment of this invention, as shown in FIG. 5, pages 202 and cover 204 of coloring book 200 are formed into a shape of a flower. In another embodiment of this invention, as shown in FIG. 6, pages 302 of coloring book 300 are formed into a shape of a house. Thus, the pages and/or the cover of the coloring book of this invention may be formed into a variety of corresponding or different shapes and sizes.

The front cover portion, the back cover portion and the plurality of pages can be formed from the same or different materials. Furthermore, the seam according to this invention can have various and alternative sizes and placements. For example, as shown in FIG. 1, the seam 28 is disposed along a longer edge or side of the rectangular coloring book 10. FIG. 5 illustrates a coloring book 100 according to another embodiment of this invention. In FIG. 5, a seam 112 of the coloring book 100 is disposed along a short portion of the periphery of the coloring book 100.

Thus, the invention provides a coloring book having a front cover portion and a back cover portion and a plurality of pages of washable material disposed between the front cover portion and the back cover portion. Individual pages and/or the plurality of pages as a whole are desirably detachable from the coloring book for more convenient removal of colors from the colorable designs and/or coloring. The pages of the coloring book can be formed as individual sheets, multiple sheets joined together to form a single page, or of a single folded sheet of washable material, such as fabric or a coated substrate. The pages of the coloring book can be formed of a single folded sheet for efficient and relatively less expensive manufacturing, while providing a relatively strong and aesthetically pleasing seam. The support sheets for the pages of the coloring book of this invention provide stiffness to make the individual pages of the coloring book easier to color on and/or manipulate. The coloring book of this invention can be used and reused. For example, the coloring book of this invention can be passed along from an older sibling to a younger sibling within the same family as the older child grows out of the age of using coloring books.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A coloring book comprising:
a plurality of pages of washable material bound together wherein at least one page of the plurality of pages includes a colorable design, wherein following coloration, each page of the plurality of pages is washable to remove color from the colorable design.

2. The coloring book of claim 1, wherein at least one page of the plurality of pages is colorable with a crayon.

3. The coloring book of claim 1, wherein at least one page of the plurality of pages is colorable with a marker.

4. The coloring book of claim 1, wherein each page of the plurality of pages is independently removable from the coloring book.

5. The coloring book of claim 1, wherein at least one page of the plurality of pages comprises a composite material.

6. The coloring book of claim 5, wherein the composite material is a coated substrate.

7. The coloring book of claim 6, wherein the coating is smooth.

8. The coloring book of claim 1, further comprising a removable cover formed outside the plurality of pages.

9. The coloring book of claim, further comprising a pouch, wherein at least one coloring instrument is storeable in the pouch.

10. The coloring book of claim 1, wherein each page of the plurality of pages comprises a front page side and a back page side and wherein at least one of the front page side and the back page side comprises a colorable design.

11. The coloring book of claim 1, wherein each page of the plurality of pages comprises a sheet of fabric.

12. The coloring book of claim 1, wherein the plurality of pages comprise a single folded sheet of fabric.

13. The coloring book of claim 1, wherein the plurality of pages are removable from the coloring book.

14. The coloring book of claim 1, wherein at least one page of the plurality of pages comprises a decorative shape.

15. The coloring book of claim 8, wherein the cover comprises a decorative shape.

16. A coloring book comprising:
a cover comprising a front cover portion and a back cover portion;
a plurality of pages of washable material bound along an edge and disposed between the front cover portion and the back cover portion;
wherein at least one page of the plurality of pages comprises a colorable design; and
wherein colors are removable from the colorable design and the colorable design is reusable for multiple uses.

17. The coloring book of claim 16, wherein each page of the plurality of pages is independently removable from the coloring book.

18. The coloring book of claim 16, wherein at least one page of the plurality of pages has a decorative shape.

19. The coloring book of claim 16, wherein at least one page of the plurality of pages comprises a coated substrate.

20. The coloring book of claim 16, wherein at least one page of the plurality of pages comprises a pocket, wherein a support sheet is removably insertable into the pocket.

21. A coloring book comprising:
a cover comprising a front cover portion and a back cover portion;
a plurality of pages of fabric bound along a seam and disposed between the front cover portion and the back cover portion;
a colorable design on at least one page of the plurality of pages, wherein colors are removable from the colorable design and the colorable design is reusable for multiple uses; and
wherein the plurality of pages are removable from the coloring book.
